(19) United States
(12) Patent Application Publication
(10) Pub. No.: US 2010/0096197 A1
(43) Pub. Date: Apr. 22, 2010

(54) POWERED TRAILER FOR PROPELLING A BICYCLE

(76) Inventor: Thomas B. Stoddart, Nantucket, MA (US)

Correspondence Address: Daniels Patent Law PLLC, 43 Centre Street, Concord, NH, 03301, US

(21) Appl. No.: 12/603,248

(22) Filed: Oct. 21, 2009

Related U.S. Application Data
(60) Provisional application No. 61/107,140, filed on Oct. 21, 2008.

(51) Int. Cl. B62M 7/14

(52) U.S. Cl. 180/11; 280/481

(57) ABSTRACT

A powered bicycle trailer for propelling a bicycle, a human rider and cargo having frame, a vehicle-mounted adapter that dismountably attaches to a bicycle, a connecting arm for rotatably connecting the frame to the vehicle-mounted adapter such that the frame is rotatable around a vertical axis with respect to the connecting arm. The trailer having a power mechanism having a multi-functional control assembly capable of generating an output drive to a ground wheel, a power transmission system mechanically coupled to an output drive of the power mechanism and capable of driving the ground wheel and the control assembly and trailer are rapidly mountable and dismountable from the bicycle by a quick connect and disconnect mechanism.

This application claims priority from Provisional Application No. 61/107,140 filed on Oct. 21, 2008.

### FIELD OF THE INVENTION

The invention concerns a powered vehicle and particularly a powered trailer suitable for propelling a bicycle, a human rider, and cargo, the trailer and all electrical and control connections being easily and rapidly connected and disconnected from the bicycle.

### BACKGROUND OF THE INVENTION

As environmental concerns, urban congestion and the price of automobile fuel have increased alternative means of transportation have been sought. One such alternative, the human-powered, chain-driven bicycle was introduced in the late 19th century. However, the level of exertion required to operate a traditional bicycle makes it inappropriate for some applications. For example, a person who desires to ride a bicycle to work in an office environment may choose not to do so when faced with the prospect of the physical exertion that accompanies an uphill ride in warm weather.

Devices to power a bicycle are known in the art, for example U.S. Pat. No. 3,312,299 (“Kuecker Bicycle Propelling Unit”, issued Apr. 4, 1967 to Kuecker); U.S. Pat. No. 4,461,365 (“Bicycle Power Pack”, issued Jul. 24, 1984 to Diggs); U.S. Pat. No. 4,413,692 (“Power Assisting Device For A Manually Operable Vehicle”, issued Nov. 8, 1983 to Clifft); U.S. Pat. No. 5,816,349 (“Detachable Cycle Utility Carriage”, issued Oct. 6, 1998 to Hankins); U.S. Pat. No. 6,725,955 (“Powered Trailer To Propel a Two Wheeled Vehicle”, issued Apr. 27, 2004 to Bidwell).

However, the existing devices for propelling a bicycle suffer from various limitations that inhibit their usefulness. For example, attaching and removing the devices in the prior art from a bicycle is a cumbersome, time-consuming process requiring tools. For example, the device in Clifft '692 is structurally connected to the bicycle with bolts at four points and incorporates a piston that must be connected to the underside of the bicycle seat. Similarly, Kuecker '299 requires that a plate be bolted onto the bicycle as a point of attachment for the propelling unit. Kuecker '299, along with Diggs '365, also does not allow for a quick disconnection of the throttle cable running from the propelling unit to the bicycle handlebar. The prior art fails to disclose any method or apparatus to quickly attach or dis-attach cabling or other means to convey electricity or motor controls between the bicycle and trailer. These controls could include but not be limited to cable control for gas engine throttle, kill switch, Pulse Width Modulation for servo motor control, electric motor speed control, turn signals, brake lights, gauges, electric starter and power from a trailer mounted battery or generator to a bicycle lighting system. A means to quickly and securely attach a bicycle trailer with all controls and power would be extremely useful.

Additionally, the means of connecting the propelling unit to the bicycle in the prior art makes operation of the unit in conjunction with the bicycle unwieldy and possibly unsafe. For example, Diggs '365, Kuecker '299, Hankins '349 and Bidwell '955 all incorporate a side-by-side two-wheel design. This necessitates a wider turning radius and gives the vehicle a wider design that may prevent it from traveling narrow spaces and increases the chances of being struck by a car or other large motorized vehicle. Furthermore, in many of these designs the two wheel design prevents the propelling unit from leaning and since these designs do not allow the propelling unit to rotate axially in relation to the bicycle, the rider is prevented from “leaning into” turns as would be possible with a normal in-line, one-wheel configuration. Finally, the additional size and weight introduced with the second wheel and accompanying mechanical structures require the unit to devote more energy to propelling itself and make the transportation and storage of the device more labor- and space-intensive.

The point of connection of the propelling unit to the bicycle that were known in the prior art also limit the usefulness of the unit. For example, although Kuecker '299 allows the propelling unit to rotate in relation to the bicycle, the fact that the rotation point is located at the hub of the rear wheel of the bicycle means that the radius through which the propelling unit can rotate is severely limited by the interaction of the connecting arm with the wheel, which increases the minimum turning radius. The propelling unit of Hankins '349 is connected by way of a connecting arm to a point just below the bicycle seat. Yet connecting the propelling unit to a point this high on the bike causes the bicycle to be unsteady when the propelling unit applies force.

Therefore, it is desirable to overcome these disadvantages by providing a propelling unit that can be rapidly and easily connected to and disconnected from a bicycle and that complements the size, tire configuration and general physics of riding a bicycle the traditional way.

### SUMMARY AND OBJECTS OF THE INVENTION

The present invention overcomes the disadvantages and limitations of the prior art by providing a powered trailer that features a wheeled, readily connectible and disconnectible design that allows the trailer to rotate around the vertical axis in relation to the bicycle, as well as rotate around an axis parallel to the axle of the rear wheel of the bicycle.

The trailer mounts to the bicycle by way of a connecting arm equipped with a locking quick connect mechanism. By avoiding the use of bolts, tools and other time-consuming connection requirements, the trailer may be quickly mounted to the bicycle. Relatedly, the trailer features a two-part multi-functional throttle cable wherein the parts may be quickly connected or disconnected from one another. Essentially, one part of the cable stays attached to the bicycle and the other stays attached to the power means, the cables can be connected magnetically or through other mechanical means such that they can be quickly disconnected from one another and the trailer detached from the bicycle without the need to remove the cables from either the bicycle or trailer.

In the preferred embodiment of the invention the connection assembly may be a rectangular male tube that attaches to the bicycle preferably at the seat post via a tube clamp and quick cam. The tube, which can also be any shape, projects horizontally a short distance toward the rear of the bicycle. Inside the tube a rigidly fastened female multi-pin socket that faces toward the rear of the bicycle. The cable would exit the tube near the seat post toward the bicycle handlebars and would have a another connector that would allow the seat post assembly to be easily removed without removing any control surfaces on the bicycle handlebars if so desired.

The trailer has a mated receiving tube that consists of framework pieces to connect the trailer and inside the tube a rigidly fastened male multi-pin plug that connects to the female socket when the trailer is completely hitched. In this way the trailer and all electrical connections are made in a single plug-and-go connection. In order to keep the trailer from coming off, a hole is provided in the receiving tube and the hole aligns with a thumb operated spring loaded pin that drops through the hole and secures the multi-pin connectors and tubes together when the trailer is fully connected. Though it is not necessary to mount the connectors inside the tube, it is a preferred location because they are then protected from the elements or damage. It should also be understood that the genders of the parts are interchangeable and the geometry of the tubes may vary without affecting the nature of the invention.

The use of a multi-pin control attachment provides for control features such as control of a gas engine throttle, a kill switch, servo motor control using Pulse Width Modulation (PWM), electric motor speed control, operation of turn signals, brake lights, gauges, and/or electric starter. The trailer may also include a mounted battery or generator to power a bicycle lighting system with control of the power system implemented through the multi-pin controller. More sophisticated controls that may supply an on demand power boost to aid a cyclist in the navigation of hills, headwinds and long distances could also be implemented. In detaching the multi-pin control attachment, it would leave a very small amount of infrastructure that would not impede the normal usage of a bicycle. Embodiments of the multi-pin control attachment would work equally well with the one wheeled design of the trailer of the present invention or for example with a side mounted two wheeled cart or trailer.

In another embodiment of the invention, the one wheeled trailer mounts to the hub of the axle of the rear wheel of the bicycle with the locking quick connect mechanism. This connection point and the one wheeled design provides a relatively low center of balance of the trailer itself and allows the rider a more predictable and stable ride that is more similar to normal bicycle riding conditions than the examples seen in the art.

Therefore, it is an object of the present invention to allow for the quick coupling and decoupling of a powered trailer vehicle with all electrical connections to a bicycle for purposes of propulsion. Specifically, a quick connect device is taught wherein the connecting arm of the powered trailer may be quickly attached and detached from a vehicle-mounted adapter. Further, a throttle cable structure and/or multi-pin connector is taught that allows the rapid connection and disconnection of two parts of the cable assembly in order that the means of controlling operational features of the trailer may be retained in place on the bicycle and on the trailer even when the trailer is not attached to the bicycle, should that be desired.

It is a further object of the present invention to provide a means by which the trailer has a minimal effect on the normal physics and sensations affecting a bicycle rider. Specifically, in the present embodiment force is transferred to the trailer where the connecting arm connects at a point near the hub of the rear wheel of the bicycle. In a traditional bicycle-riding experience, this is where the force generated by the pedaling of the user is applied to the bicycle wheel. Thus, the forces applied in the present invention are similar to those experienced in normal bicycle riding situations. Further, the one-wheeled design allows the trailer to rotate around the longitudinal axis of the bicycle, enabling it to follow the bicycle more naturally and reducing the amount of rotational torque felt by the rider when he or she leans into a turn.

Relatedly, it is an object of the present invention to allow the propelled trailer to rotate through nearly 180 degrees around the vertical axis in relation to the bicycle. This allows the bicycle and trailer to navigate a tighter turning radius. Specifically, the present invention allows the trailer to rotate at a pivot point located behind the rear wheel of the bicycle. This solves some of the problems of the prior art by ensuring a tighter turning radius and prevents interference between the connecting arm and the rear wheel of the bicycle. Alternatively, a dual pivot point could be located above the rear wheel of the bicycle, from a connection point at the seat of the bicycle. The dual pivot would allow rotation of nearly 180 degrees around the vertical axis in relation to the bicycle as well as rotation around an axis parallel to the rear wheel of the bicycle, and provide for a single frame connection point between the trailer and the bicycle. Three degrees of rotational freedom could also be provided using a ball and socket to accommodate a two-wheeled cart.

It is also an object of the present invention to provide a powered bicycle trailer for propelling a bicycle and a human rider, comprising a trailer frame, an adapter for connecting to a bicycle, a connecting arm for rotatably connecting the trailer frame to the adapter such that the frame is rotatable about at least one of a horizontal axis and a vertical axis relative to the bicycle, a power generation system that attaches to the trailer frame, a first control assembly that attaches to the bicycle, facilitating rider control of the power generation system and a second control assembly that attaches to the power generation system, a ground engaging member, a power transmission system mechanically coupled to an output drive of the power generation system and capable of driving the ground engaging member, and wherein the trailer frame and control assembly is rapidly mountable and dismountable from the bicycle by a quick release coupling between the first and second control assemblies.

It is a further object of the invention to provide a powered bicycle trailer for propelling a bicycle, a human rider, and cargo, comprising a frame for attachment to a bicycle, a vertical and horizontally aligned axis of rotation positioned between the frame and the bicycle permitting relative rotation of the frame relative to the bicycle, a power means supported on the frame having a first throttle cable and capable of generating an output drive, a power means control system for mounting on the bicycle comprising a throttle control attached to a second throttle cable and a quick connect and disconnect device for connecting the second throttle cable to the first throttle cable, a power transmission system mechanically coupled to an output drive of the power means for driving a ground engaging member, and wherein the trailer is rapidly mountable and dismountable via the quick connect and disconnect device between the first and second throttle cables.

Finally, it is an object of the invention to provide a method of propelling a bicycle, a human rider, and cargo, comprising the steps of attaching a trailer having a frame to a bicycle, positioning a vertical and horizontally aligned axis of rotation between the frame and the bicycle permitting relative rotation of the frame relative to the bicycle, supporting a power means on the frame having a first throttle cable and capable of generating an output drive, mounting a power means control system on the bicycle comprising a throttle control attached to a second throttle cable and a quick connect and disconnect device for connecting the second throttle cable to the first throttle cable, coupling a power transmission system mechanically between an output drive of the power means and a ground engaging member, and one of rapidly mounting and dismounting the trailer from the bicycle via the quick connect and disconnect device between the first and second throttle cables.

### BRIEF DESCRIPTION OF THE DRAWINGS

The invention will now be described, by way of example, with reference to the accompanying drawings in which:

FIG. 1 is a side view of an embodiment of the powered trailer of the present invention attached to a bicycle;

FIG. 2A is a rear view of the powered trailer with a cowling;

FIG. 2B is a side view of the powered trailer with the cowling;

FIG. 3 is an exploded view of the bicycle hub and quick-clamp mounting adapter apparatus;

FIGS. 4A and 4B are a front view of the hub and a perspective view of the hub nut with the mounting adapter apparatus;

FIG. 5A and 5B are a top and side view of a joint between the front and rear forks of the trailer frame;

FIG. 6 is side view of the trailer with a dual pivot mounting apparatus attached at the seat post of the bicycle;

FIGS. 7A and 7B are rear views of two embodiments the dual pivot mounting apparatus attached at the seat post of the bicycle;

FIG. 8 is a top view of the multi-pin tube connector;

FIG. 9 is a side view of the trailer with a rack and external fuel cell and a multi-pin tube connector;

FIG. 10A and 10B are a perspective view of first embodiment of the throttle cable support housing and throttle line connection;

FIG. 11A and 11B is a perspective view of a first embodiment of a kill switch circuit connection;

FIG. 12A and 12B are a perspective view of a further embodiment of the throttle cable support housing and throttle line connection;

FIG. 13 is a top view of the multi-pin connector with external mechanical throttle cable.

FIG. 14A and 14B is a side elevation view of another embodiment of the throttle and kill switch of the present invention;

FIG. 15 is a perspective view of the trailer without the engine and drive wheel detailing the power transmission system;

FIG. 16 is a perspective, exploded view of the belt tensioner;

FIG. 17A-17C is a diagrammatic representation of the suspension and folding system for a folding cart and drive system, and

FIG. 18 is another embodiment of the quick release mounting system.

### DETAILED DESCRIPTION OF THE PREFERRED EMBODIMENTS

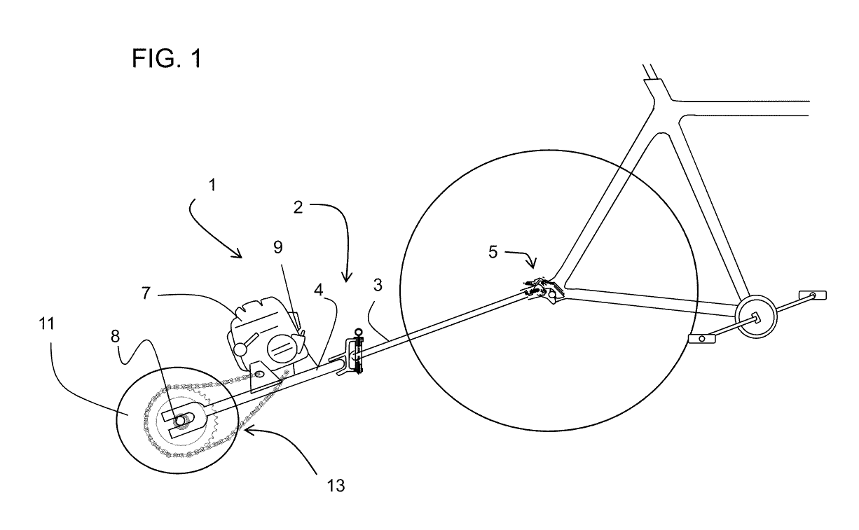

The present invention relates to a powered trailer 1 as shown in FIG. 1 which is capable of propelling alone or as an assist to a bicycle, a human rider and cargo. The trailer 1 may be configured to attach to any style of bicycle, whether mountain, street, hybrid, recumbent, tandem, multi-speed or one speed. Additionally, it is to be appreciated that the present invention could be adapted to work with other vehicles, for example a scooter or other two-wheeled vehicle.

Observing FIG. 1, the invention in accordance with one embodiment is the powered trailer 1 for propelling a bicycle. In general, the powered trailer 1 includes a trailer frame 2 consisting of a front fork 3 and a rear fork 4, a bicycle mounting adapter 5, a motor or engine 7, a fuel cell internally located with the engine or positioned external thereof, an engine control system 9, a ground engaging drive wheel 11 and a power transmission system 13.

The powered trailer 1 may be an aftermarket attachment for most all standard bicycles. In other embodiments, the powered trailer 1 and bicycle may also be sold together as a unit. In the latter case, the control system 9 including all cabling, throttle controls and other features of the invention as described in detail below may be incorporated more directly into the design of the bicycle.

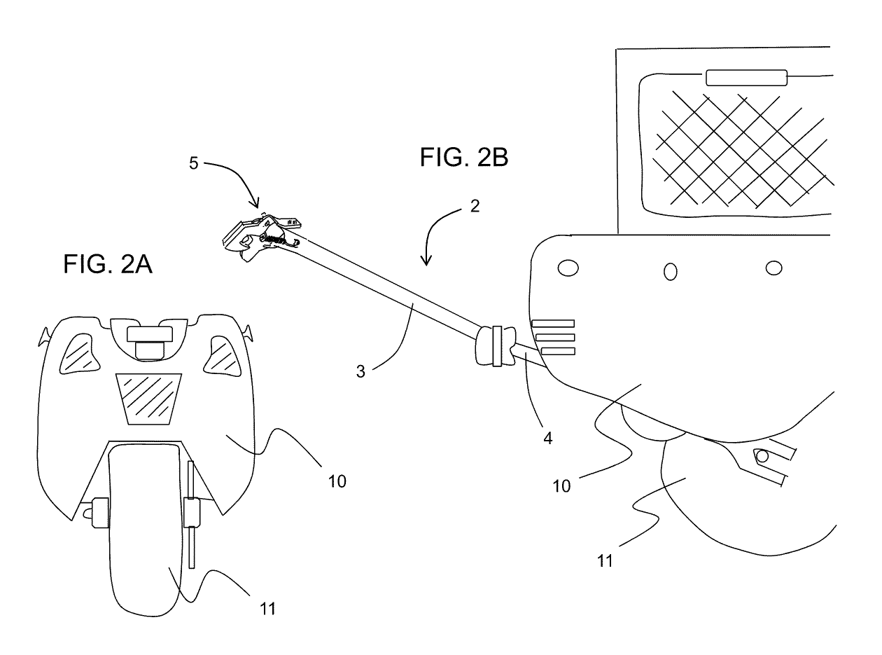

The present embodiment employs the rear fork 4 of the frame 2 for supporting the drive wheel 11, as well as the engine 7 and power transmission system 13. Though the frame 2 may be constructed of any material, it is preferably constructed of strong, durable metal, such as steel or aluminum. Alternatively, lighter weight metals or composites may be used. The rear fork 4 is swivably connected to the front fork 3 which, in turn, connects to the bicycle as discussed in further detail below. The frame 2 and, in particular, the rear fork 4 may also be covered and support a covering or cowling structure 10 made of plastic, fiberglass, carbon fiber or other moldable material as shown in FIGS. 2A, 2B for purposes of reducing the noise of the engine 7 and to provide protection from the elements as well as protection from moving parts that may cause injury. The cowling would further make a fashion statement and provide some aerodynamic streamlining as well as logo space. Furthermore, portions of the frame 2 may be extensible to create storage space and carrying handles in cooperation with the cowling structure 10 if desired.

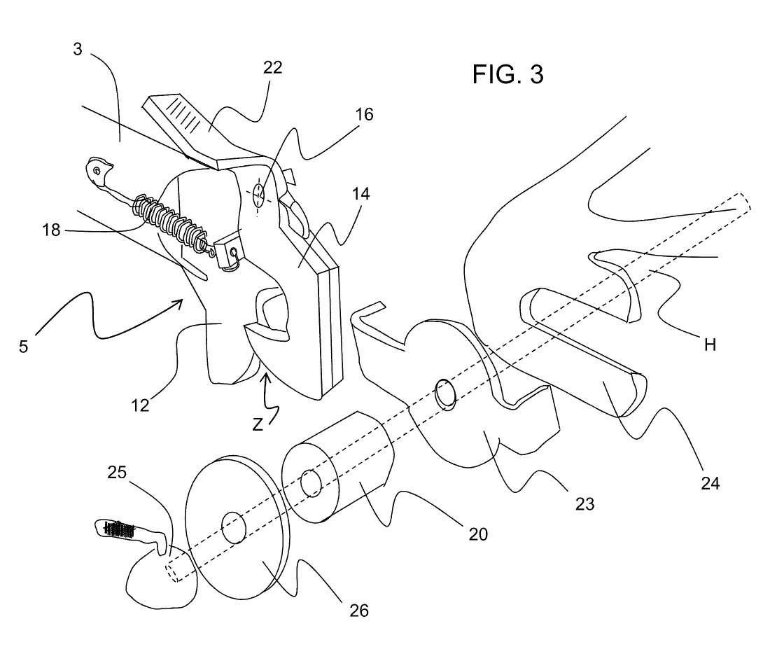

For the frame 2 to be universally attachable to a variety of bicycle designs and styles, the bicycle-mounting adapter 5 is used, as is best seen in FIG. 3, to facilitate simple attachment and detachment of the trailer 1. The bicycle-mounting adapter 5 is preferably composed of steel or other durable metal; however, it is to be appreciated that any rigid material may be used in making the adapter 5 or parts thereof. In the present embodiment, the adapter 5 is mounted to each free end of the front fork 3 so as to releasably engage the rear hub H of the bicycle when the powered trailer 1 is hooked up to drive the bicycle. The adapter 5 includes at least one slotted plate 12 defining a substantially vertically aligned slot Z supporting a springably pivoted catch 14, which rotates about a pivot 16 relative to the slotted plate 12 and slot Z. In a spring biased position, the catch 14 is pulled by a spring 18 to cooperatively define with the slot Z a retaining passage, which secures the front fork 3 to a receiving post 20 attached on the bicycle, as discussed in further detail below. A user may easily release the adapter 5 from connection with the bicycle and receiving post 20 by actuating a thumb release 22 at one end of the pivoted catch 14 to rotate the pivoted catch 14 away from a position encircling the receiving post 20 and thereby open the slot Z in the slotted plate 12 and then remove the front fork 3 by lifting vertically up on the frame 2 to disconnect the trailer 1 from the bicycle.

An important feature of the present invention and the above discussed adapter arrangement is that it is designed mainly for the trailer 1 to push the bicycle rather than the bicycle to pull the trailer. The posts 20 are located next to the bicycle's rear dropouts 23 so that it can incorporate a safety that locks around the wheel frame 24 of the bicycle wheel hub H to prevent the wheel hub H from being pushed off the dropout 23. The post 20 may be one piece or several pieces sandwiched together and held in place by the bicycle's quick release skewer 25 and washer 26 as shown in FIG. 3. Another advantage to this system, besides its greatly increased safety, is its simplicity. Generally, only a slightly longer hub H is needed (which are readily available) to hold the assembly in place and the spring loaded latch system described above greatly facilitates the connection/disconnection process.

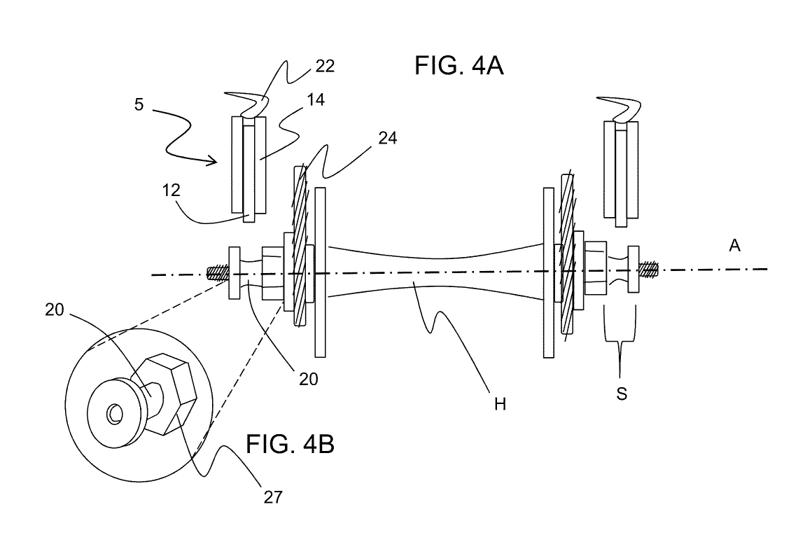

The arms of the front fork 3 of the cart trailer 1 attach to each side of the hub H of the bicycle's rear wheel by way of the receiving posts 20, the plate 12 and the spring loaded catch 14 as shown in FIG. 4A. With the front fork 3 connected in a manner as described above, the releasable adapter 5 connection allows the front fork 3 and the frame 2 to rotate coaxially around, or nearly parallel thereto, an axis A as defined by the rear axle and the hub H of the bicycle. The receiving post 20 can be designed to integrate with a rear hub nut 27 as shown in FIG. 4B so that the receiving post(s) are co-axial with the rear axle and define a circumferential space S at either side of the rear hub H positioned outside of the bicycle frame 24 so as to facilitate receiving the mounting adapter 5 in the circumferential space S described above. This arrangement prevents unexpected and undesirable forces from being exerted on the bicycle and rider by the trailer 1. The slotted plate 12 and pivotable catch 14 secure the adapter 5 to the receiving posts 20 so that the tension spring 18 biasly retains the catch 14 about the receiving post 20 and the front fork 3 therefore rotates coaxially about or closely parallel to the rear axle of the bicycle.

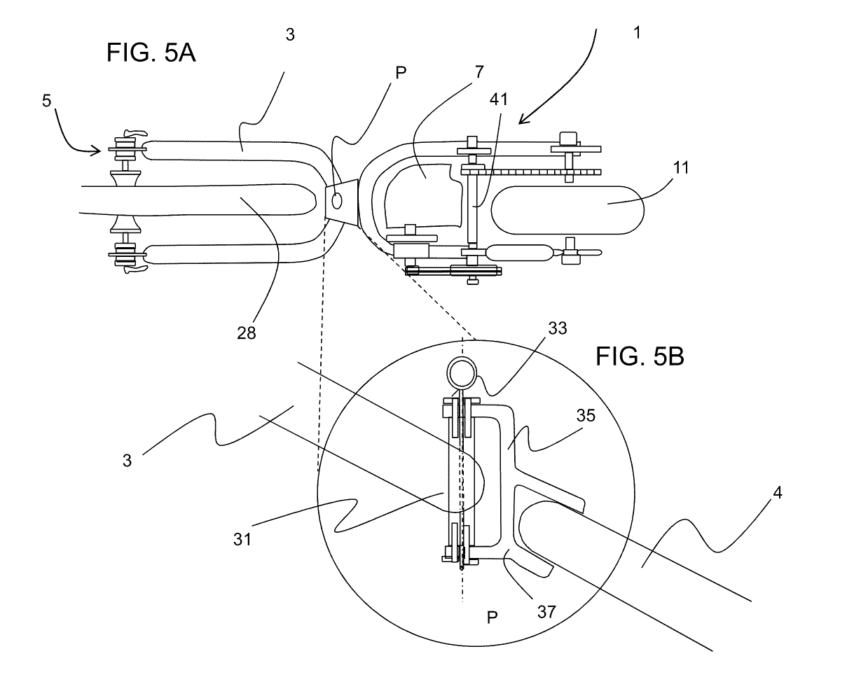

From the above described connection points of the free ends of the front fork 3 to the bicycle frame, the front fork 3 extends rearwardly in a substantially U shaped manner to a second end point slightly behind the rear wheel 28 of the bicycle as shown in FIG. 5A. At this second end of the front fork 3 is provided a passage P defining a substantially vertical axis relative to the angle that the front fork 3 extends from the bicycle. The passage P may be merely a hole, or a vertical tube 31, having a hollow center. In any event, the passage P is formed so as to be capable of receiving a vertical hitch pin 33 as seen in FIG. 5B. The front end of the rear fork 4 comprises an upper hitch tongue 35 and a lower hitch tongue 37 being substantially horizontal and separated with respect to one another. An opening is formed in each of the hitch tongues 35, 37 which are capable of receiving hitch pin 33. The size and orientation of the openings in hitch tongues 35, 37 and the vertical tube 31 are such that, when those parts are properly aligned, the hitch pin 33 may pass simultaneously through not only the hole and/or vertical tube 31, but also through the hitch tongues 35, 37 and thereby secure the rear fork 4 to the front fork 3 so that there is relative rotation about the hitch pin 33 between the front and rear fork 3, 4. By rotatably attaching front fork 3 to the rear fork 4 in this manner, the rear fork 4 supporting the engine 7 and ground wheel 11 may then rotate without applying substantial influence or force to the front fork 3 and the connection point of the adapter 5 with the bicycle. This greatly improves the handling and turning radius of the trailer 1 over those propelling units existing in the art which do not have such an intermediate pivot point. It should be appreciated that the attachment means of the present embodiment is but one solution and the present invention contemplates any manner by which the frame 2 may be attached to the connecting arm such that the frame 2 is allowed to rotate in a substantially horizontal plane, i.e., along the supporting ground surface through substantially 180 degrees about the hitch pin 33 in relation to the front fork 3.

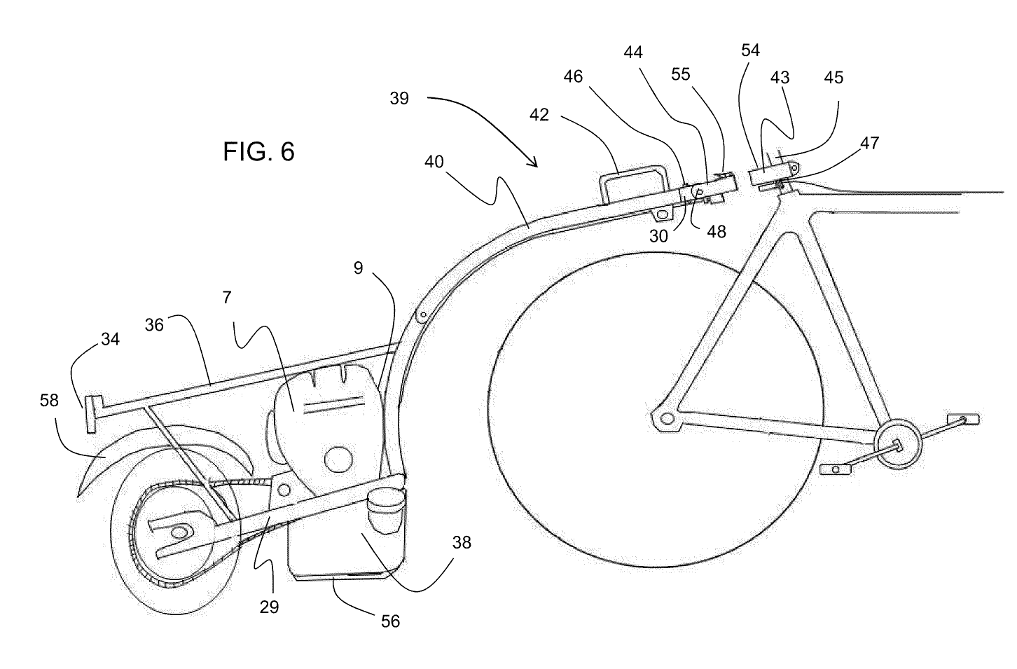

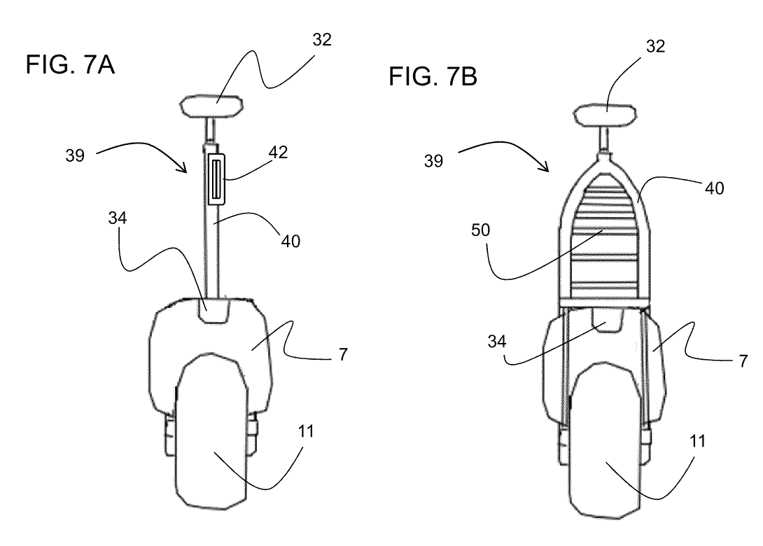

It is to be appreciated that other receiving pin(s) or posts separate, i.e., non coaxial with the rear axle could be provided as well to which the adapter 5 could also be secured. The receiving pin(s) or post could potentially be supported by a portion of the bicycle frame or additional support mounted on the bicycle so that the adapter 5 and hence the front fork 3 of the frame 2 is pivotably releasably attached about a separate axis parallel, but spaced from the rear axis A as defined by the hub H. In a further embodiment as shown in FIG. 6 the trailer connection point could be above the rear wheel of the bicycle. In this embodiment a trailer tow bar 39 extends high enough above the rear wheel of the bicycle so that it is not likely to rub against the tire under normal riding conditions. The tow bar 39 consists of one or more longitudinal arms 40 that go between the quick connector located near the bicycle seat and the powered trailer. A single longitudinal arm 40 as shown in FIG. 7A reduces the weight of the trailer 1 and could be provided with a handle 42 to easily maneuver the trailer 1 for attachment to the bicycle or for storage upon disconnecting from the bicycle. The handle or arm may also incorporate a locking pivot point (not shown) to allow the tow bar 39 to fold up for convenient storage of the trailer 1. If two or more arms 40 are used then a framework 50 of cross members could provide a significant cargo rack 36 along the length of the tow bar 39 as shown in FIG. 7B.

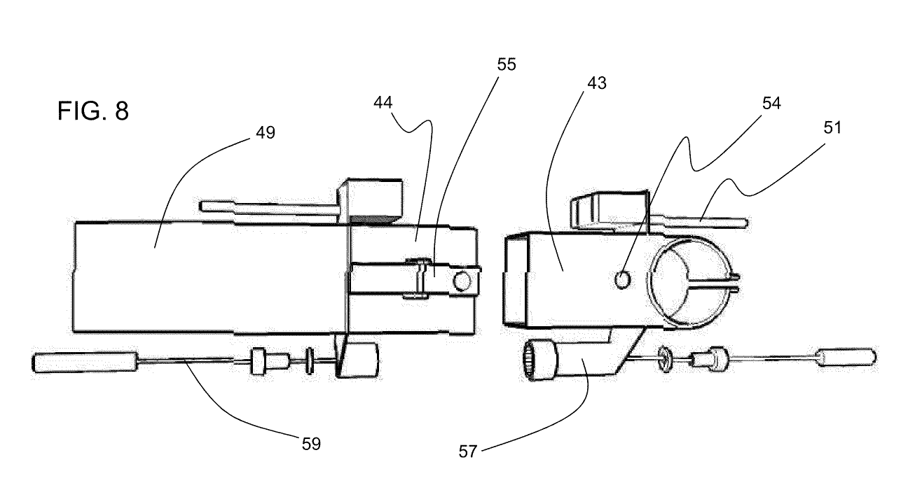

The arm or arms 40 extend from a base frame 29 of the trailer 1 and attach to a dual pivot connector 44. The dual pivot connector 44 consists of a vertical pivot pin 46 and a horizontal pivot pin 48 that attach using extenders 30 to the arm 40. The attachment of the arm 40 to the vertical pivot pin 46 provides for nearly 180 degrees of rotation around the vertical axis in relation to the bicycle while the horizontal pivot pin 48 connection separates the side to side movement of the trailer 1 from the bicycle, giving greater safety and stability to the rider. At a point beyond the horizontal pivot 48, the pivot connector 44 attaches to an extension connector 43 that is mounted to the seat post 45 of the bicycle via a seat post connector clamp 47. The extension connector 43 has an opening 54 that extends through the connector 43. The pivot connector 44 has a pressure operated spring loaded pin 55 that aligns with the opening through the extension connector 43 as shown in FIG. 8. The alignment of the pin 55 with the opening 54 ensures that the trailer 1 is fully connected to the bicycle. The dual pivot points 46 and 48 of the pivot connector 44 should be provided as near as possible to the seat post 45 of the bicycle to allow 2 degrees of rotational freedom about the horizontal and vertical axis. Either or both of these pivot points could be located on the bicycle side or on the trailer side of the quick connector.

Additionally, FIG. 6 shows a fuel storage canister or battery box 38 placed under the trailer 1 in front of the drive wheel 11. A skid plate 56 could be affixed to the fuel storage canister or battery box 38 to help the cart 1 slide over curbs and other obstacles. The plate 56 could be comprised of several longitudinal skids that may be an integral part of the fuel tank or battery box 38. Because the canister 38 is located so close to the rear wheel of the bicycle, when the rear wheel of the bicycle is up on a curb or object, the canister 38 is then conveniently positioned and angled to provide a ramp for the trailer to then slide up over the curb or object. A fender 58 to help guard against dirt and spray and a rear brake light 34 are also shown. The trailer 1 could also be outfitted with brake lights, turn signals and rear and side reflectors.

The above described system may be used to quickly attach to two-wheeled powered trailers as well. On a two-wheeled trailer, the wheels would be mounted side by side and far enough apart to be stable around turns. By placing batteries, motors, etc in a low center of gravity, considerable stability could be maintained. Additionally, to improve maneuverability and steadiness, instead of using a dual pivot assembly that provides two degrees of rotational freedom, a ball and socket joint located near the seat post is used to provide three degrees of rotational freedom, (the third degree would be so that the bicycle could lean while the two-wheeled powered trailer remains level). Because of the additional size and weight of the cart, battery powered hub motors preferably could be used however any method of powering the trailer would be acceptable. In a further embodiment, sensors or switches are placed near the vertical pivot point so that the motor to the trailer could be disengaged or shut off when the cart is angled too far to either side in order to prevent injury to the operator from shifting of the weight of the cart.

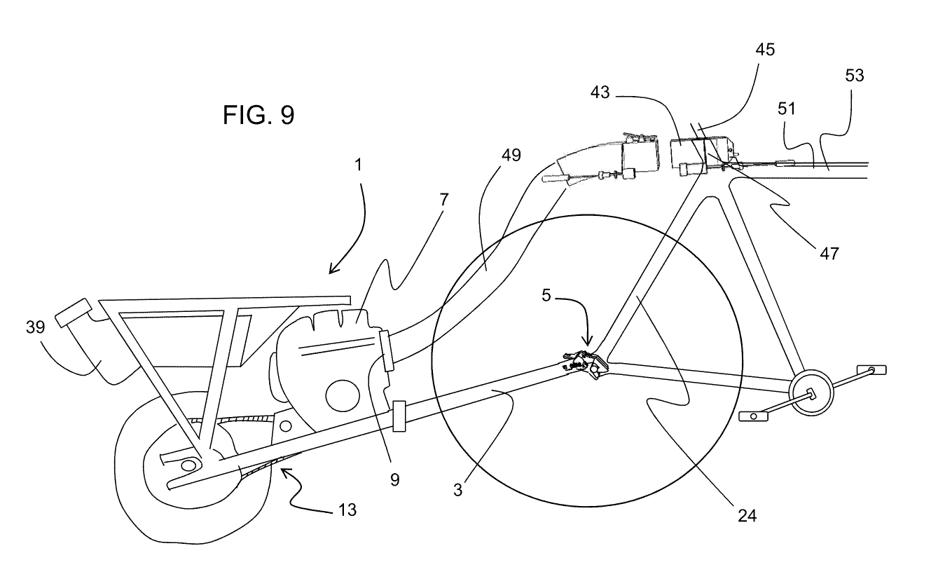

In the present embodiment the trailer 1 is equipped with a motor or engine 7, in this case, a fuel-powered engine accompanied by the fuel canister 38 as shown in FIG. 6 or by a rear fuel tank 39 as shown in FIG. 9. The engine 7 employs an output drive shaft 41 for generating torque to rotatably drive the ground engaging wheel 11 for propulsion of the trailer 1 and bicycle. Although the present embodiment employs a conventional gas-powered engine by way of example, it can be appreciated that any prime mover capable of transferring energy to the ground engaging wheel 11 would be possible, including diesel fuel, electric power, ethanol, or any known or currently unknown energy source.

Because this is a motorized device, a control system that can be quickly connected and disconnected from the bicycle is required. As shown in FIG. 9 with the first embodiment of the mounting adapter 5 attached to the rear hub H of the bicycle, a first portion of a cable and multi-pin connector is connected to the trailer 1 and a second portion is connected to the bicycle. In this embodiment the rectangular extension connector 43 as described above attaches to the bicycle preferably at the seat post 45 via the seat post connector clamp 47. Cabling 51 from the extension connector 43 extends along the bicycle frame 53 to control surfaces on the bicycle handlebars. The entire seat post connector clamp 47 is easily removed from the bicycle without removing any control surfaces on the bicycles handlebars if so desired. The extension connector 43 projects roughly horizontally a short distance toward the rear of the bicycle. Attached to the extension connector 43 is a rigidly fastened female multi-pin socket (not shown) that accepts a male multi-pin plug (not shown) from a tube connector 49 attached to the motor control system 9 from the engine 7. Electrical cables extend from the motor control system 9 through the tube connector 49 and attach to the male multi-pin plug. The plug or sockets may be located either on the inside or outside of the tube connector 49 or the extension connector 43. It should also be understood that the genders of the parts are interchangeable and the geometry of the tubes may vary without affecting the nature of the invention. In connecting the male multi-pin plug of the tube 49 to the extension connector 43 an electrical connection would be established to provide control for a gas engine throttle, a kill switch, the PWM for servo motor control, electric motor speed control, turn signals, brake lights, gauges, electric starter and power from a trailer mounted battery or generator to a bicycle lighting system.

When connected, the tube connector 49 closely aligns along the trailer's front fork 3 and bicycle wheel frame 24. As shown in FIG. 8, the extension connector 43 has an opening 54 that extends through the extension connector 43 and aligns with a pressure operated spring loaded pin 55 from the tube connector 49. The pin 55 drops through the opening 54 in the extension connector 43 when the trailer 1 is fully connected, thus securing the electrical connectors. The tube 49 and extension connector 43 may include a cable mount 57 to attach brake or gear cables 59 from the bicycle along the tube connector 49.

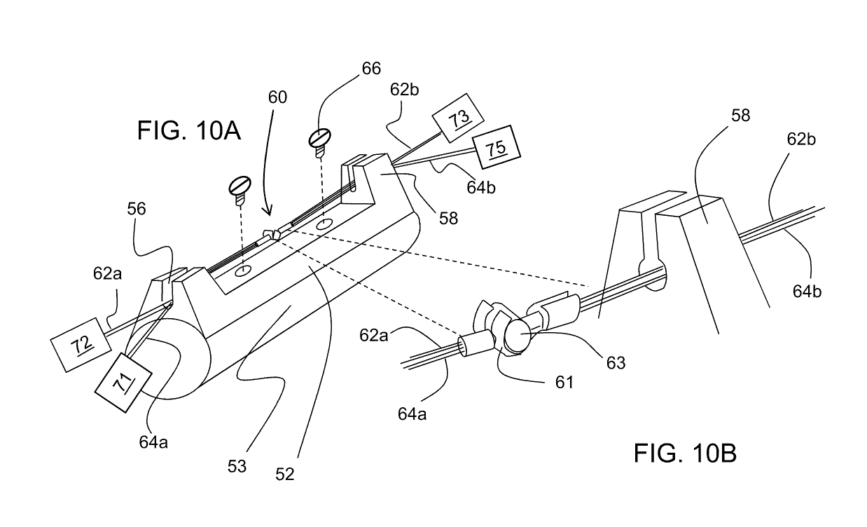

In a simplified embodiment the electrical connections as shown in FIGS. 10A and 10B may be a quick connect/disconnect mechanism 60 for only a throttle cable 62 and a kill switch cable 64. The throttle cable 62 composed of a first throttle cable 62a from the trailer and a second throttle cable 62b from the bicycle regulates the power output of the engine 7. The kill switch cable 64 is composed of a first kill switch cable 64a from the engine 7 and a second kill switch cable 64b from the bicycle that provides for almost immediate stopping of the engine 7 for safety purposes and under particular circumstances. The first throttle cable 62a is connected from a throttle arm 72 on the engine 7 to a connection with the second throttle cable 62b, which, in turn, extends from the connection of those two cables to a throttle control 73 located at one handlebar of the bicycle. By actuating the throttle control 73, the connected throttle cables 62a and 62b thereby increase and decrease the power output of the engine 7 according to the user's demands. Similarly, the first kill switch cable 64a is connected from the kill switch 71 (on /off button) on the engine 7 to a connection with the second throttle cable 64b, which, in turn, extends from the connection of those two cables to a kill switch button 75 located at one handlebar of the bicycle. The kill switch 71 may be activated at both the kill switch button 75 on the handlebars and at the kill switch 71 on the engine 7.

As shown in FIG. 10A a housing 52 for stabilizing the quick connect/disconnect mechanism 60 may also be provided. The housing 52 is supported by a portion of the bicycle or trailer frame 53 using a screw or other attachment 66. A cable retaining structure 58 is provided at each opposing end of the housing 52 for directly supporting the first and second throttle cables 62a and 62b and/or kill switch cables 64a and 64b. The first throttle cable 62a extending from engine 7 and the trailer 1 is secured in the housing by inserting the cable 62a through an axially aligned slot 56 in the retaining structure 58, which again facilitates the quick connect/disconnect of the throttle cables 62 and 64, when necessary.

The quick connector 60 is a mechanical clip 61 shown in FIG. 10B affixed to the end of each or of one set of cables 62a and 64a from the trailer. The mechanical clip 61 connects to the bicycle cables 62b and 64b by inserting a barrel connector 63 affixed to the end of each or of the set of bicycle cables 62b and 64b into the slot of the mechanical clip 61. In this simplified connection a set of one throttle cable 62 and one kill switch cable 64 may be connected to a single clip or barrel and allow the cables 62 and 64 to be simultaneously connected and disconnected.

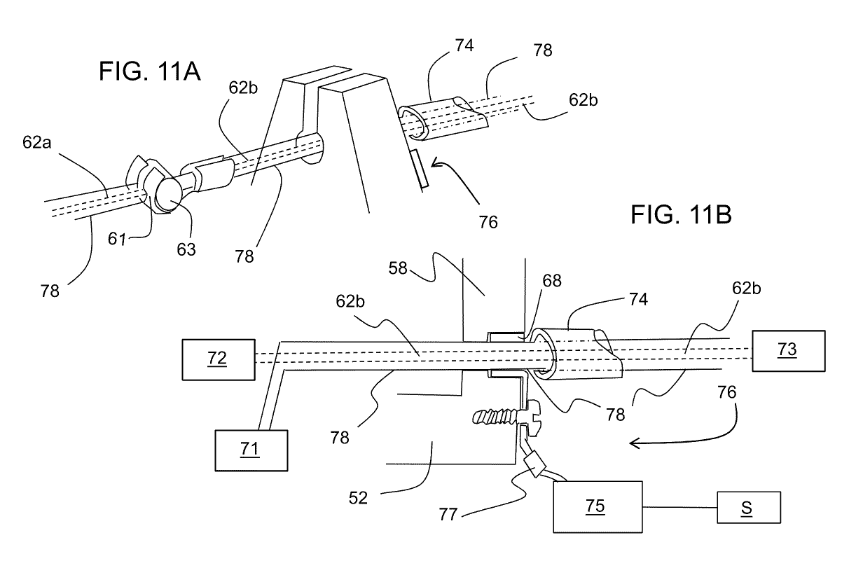

Alternatively, by electrically isolating the throttle cable 62 from the frame 53 of the trailer 1 and/or the bicycle as shown in FIG. 11A and 11B, a kill switch circuit 76 would provide for a single cable to be used for both the throttle and kill switch. This kill switch circuit 76 includes a first circuit branch or wire 77 extending from the manual button 75 or a safety switch S, for example positioned on the handlebars of the bicycle, to a connection with the housing 52. The manual switch 75 or the safety switch S may also be positioned on the seat or another position on the bicycle and may be activated by the user's movements or body positioning relative to the bicycle whether such movements and body positioning are voluntary or otherwise. The housing 52 may also alternatively be mounted on the frame of the trailer 1 and the first circuit wire 77 would extend from a connection with the housing to the motor kill switch 71.

The first circuit branch 77 of the kill switch circuit 76 is connected to a metal sleeve 68 secured to the housing 52 which defines a passage for receiving a portion of the metal sheath 78 of the throttle cable wire 62. The metal sleeve 68 is in direct contact with the metal sheath 78 of the throttle cable wire and therefore is able to send any electrical signal for “killing” i.e., stopping the engine along this sheath. Other portions of the cable will be insulated 74 for protection. It is to be appreciated that the insulating nature of the housing 52 fabricated from plastic or other non-conductive material ensures that the kill switch circuit 76 is insulated from the bicycle or trailer frame 53. This is an important feature of the present invention because it allows for quick connect and disconnect of the kill switch circuit 76 when the trailer 1 is coupled/decoupled from the bicycle. When the throttle cable 62 is disconnected and removed from engagement with the housing 52, the metal sheath 78 is cooperatively removed from its connection with the metal sleeve 68 in the housing 52. Thus, in a single manual and mechanical operation, the throttle cable 62 and kill switch circuit 76 can be connected and disconnected. Besides ease of connectivity, this system also has the additional benefit that the trailer 1 cannot be operated without the kill switch circuit 76 connected.

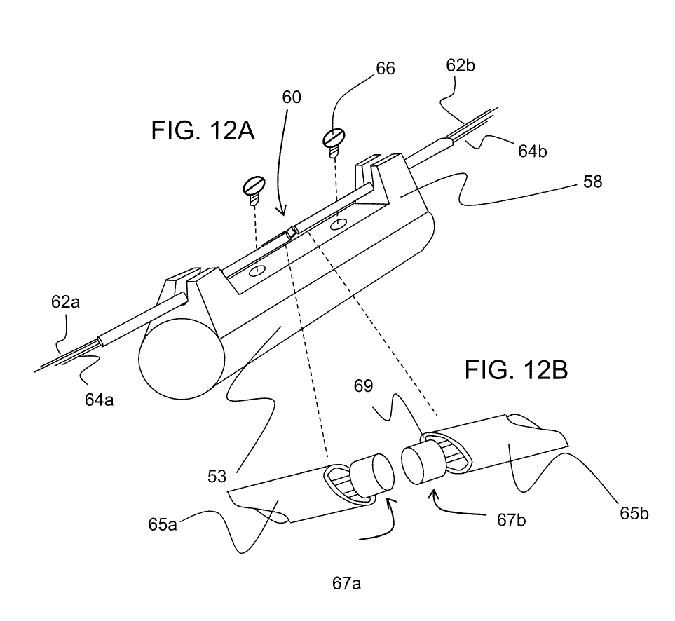

In a further embodiment as shown in FIG. 12A and 12B the quick connector 60 is a magnetic system that consists of two non-ferrous cylinder tubes 65a and 65b of plastic or other flexibly rigid material. Inside each tube 65 is a magnet 67 affixed to the end of each of the throttle cables 62a and 62b and/or to the end of each of the kill switch cables 64a and 64b or to each set of a throttle cable and/or the kill switch cable, 62a and 64a and 62b and 64b respectfully. An oversert 69 may be provided to insure that the tubes 65a and 65b align properly. As the two tubes 65 are drawn together the magnets 67 of similar diameters align and abut when the quick connector 60 is fully engaged. The tube 65b on the bicycle side should be of extended length so that activation of the throttle control 73 on the handlebars can pull the connected magnets 67a and 67b through the tube 65b thus moving the throttle arm on the engine 7. The connected magnets 67 such as of neodymium should be strong enough to operate the throttle body without being separated, but weak enough to be easily disconnected when the trailer is unhitched.

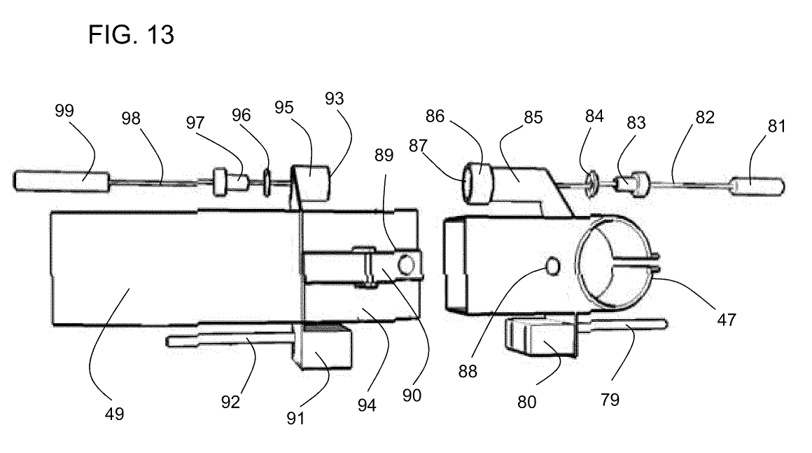

The above embodiments could be combined in that the multi-pin connector or wiring harness may be separated from a mechanical throttle cable, but both the harness and cable could still be connected simultaneously with the trailer 1 to the bicycle by using the multi-pin connector tube 49 and a quick connection magnetic system for the mechanical throttle cable as shown in FIG. 13. The magnetic system as described above consists of two non-ferrous tubes 85 and 95 of similar diameters that align and abut when the multi-pin connector tube 49 is fully engaged. An oversert 86 may be provided to insure that the tubes are lined up properly. Inside each tube is a magnet 87 and 93 that is attached to either end of each throttle cable 82 and 98. The tube 85 is attached so that activation of the throttle 73 on the handlebars can pull the connected magnets 87 and 93 through the tube 85 thus moving the throttle arm 72. As noted above, the connected magnets 87 and 93 are strong enough to operate the throttle arm 72 without being separated but weak enough to be easily disconnected when the trailer 1 is unhitched.

Any electrical connections between the bicycle and trailer may be made by means of the electrical plug 91 and socket 80. Also shown are throttle cable adjusters 83 and 97 with throttle cable adjuster locknuts 84 and 96 that allow proper adjustment of the throttle cable length. The magnet guides 85 and 95, throttle cable adjusters 83 and 97, and throttle cable adjuster locknuts 84 and 96 may have lengthwise slots so that the magnet and cable assemblies may be removed for replacement or cleaning. A light non-ferrous spring (not shown) may be placed inside the tube 95 in order to keep the magnet 93 towards the cart end of the tube 95 when disengaged so that it comes in contact with the other magnet 97 when hitching the trailer. A mu-metal shield may surround the non ferrous tubes 85 and 95 to prevent external magnets or metallic objects from affecting the smooth linear action of the magnet assembly. Further, a kill switch 89 may be located under the thumb latch 90 so that the engine can't be run or started if the latching pin 88 is not fully engaged. Also it would automatically shut off the engine if one attempts to disconnect the cart with the engine on.

As described in detail above, a normal electrical harness could be supplied that could also provide an easy means of connecting any electrical systems between the bicycle and the trailer 1. Alternatively, the throttle control could either be a fly-by-wire control or a wireless control that would comprise of a sending unit or transmitter mounted on the bicycle and a receiver and servo connected to the throttle arm 72 of the motor 7 mounted on trailer 1. This method could also be used to operate the kill switch 71.

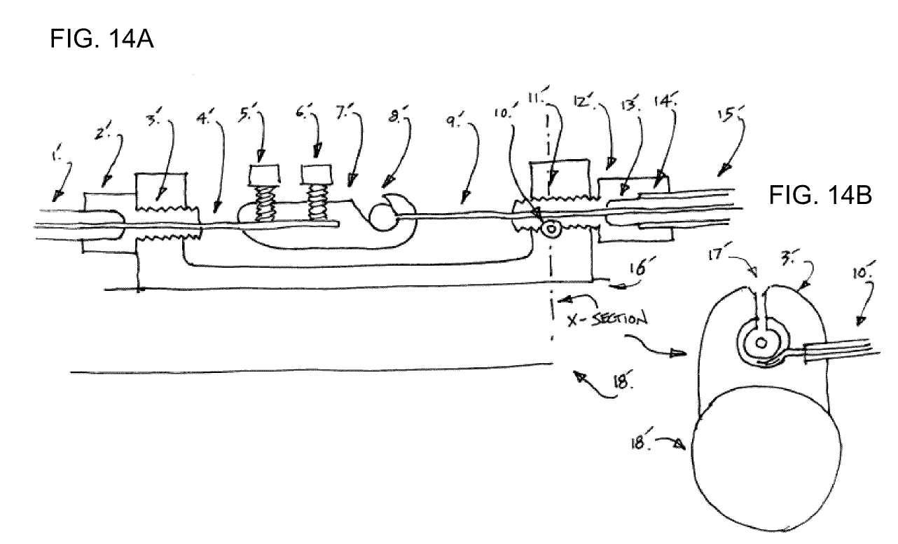

Another embodiment of the throttle and kill switch, as shown in FIG. 14A and 14B, includes the use of slotted cable adjusters. This embodiment details improvements made to the previously described throttle and kill switch. The cable length adjusters are shown 2′ and 12) as well as the following structure:

1′ Throttle cable with shield to engine

2′ Slotted cable adjuster

3′ Threaded hole in housing

4′ Throttle Cable

5′ Clamping Screw

6′ Clamping Screw

7′ Electrically Non-Conducting Clip

8′ Barrel

9′ Throttle Cable to Controller on Bicycle

10′ Wire to Kill Switch on Motor

11′ Threaded Hole in Housing

12′ Slotted Cable Adjuster

13′ Metal Sleeve

14′ Insulated Sleeve

15′ Throttle Cable to Controller on Bicycle

16′ Housing

17′ Slot in Cable Adjuster and Housing

18′ Front fork of Trailer

This embodiment allows the throttle cable 9′ to be easily removed from the cart 1 by unfastening the clip 7′ and barrel 8′ and then sliding the cable out through the slot 17′. The cable may be adjusted by the turning the adjusters 2′ and 12′. The kill switch circuit 10′ is connected to the slotted cable adjuster 12′ which is electrically connected to the sleeve 13′ and cable 9′. As shown in FIG. 14B, the kill switch wire 10′ is sandwiched in the threads of the adjuster 12′. Alternatively, the wire 10′ could be fastened by any other means such as soldering, clamping, etc to the slotted cable adjuster 12′. The clip 7′ is electrically nonconducting so that the kill switch circuit 10′ is normally isolated from ground. Alternatively the throttle cable 4′ may be electrically connected to the kill switch 10′ allowing the throttle cable 4′ to double as the kill switch wire. In this embodiment the throttle cable sheath is electrically non-conducting.

Observing again FIG. 1, the ground engaging drive wheel 11 is mounted to frame 2 such that it can freely rotate on an axle 8 held by the drop-outs at the end of the rear forks 4 and be driven by engine 7 via the power transmission system 13. The drive wheel 11 can be made of any suitable material, such as a solid or inflatable piece of rubber or other hydrocarbon polymer. Furthermore, the drive wheel 11 may not comprise a wheel at all. For example, it may instead comprise a spherical ground engaging member such as a ball rather than conventional disc shaped tires of the present embodiment.

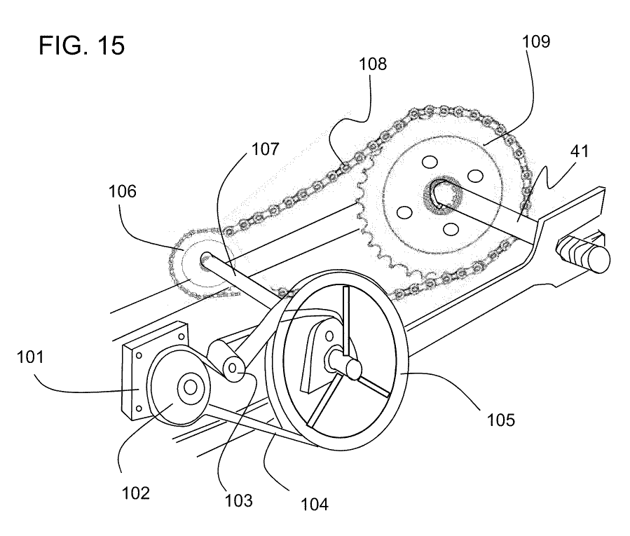

The drive train of the trailer 1 is shown in FIG. 15 with the engine 7 and the drive wheel 11 removed for clarity. The present invention uses a power transmission system 13 to harness the torque from an output drive shaft 41 of engine 7 connected through a centrifugal clutch 101 to a first pulley 102 and transfers power through a second pulley 105 to a rear sprocket 106 for influencing the drive wheel 11 to assist in propulsion of the bicycle. The power transmission system 13 includes the first pulley 102, which is mechanically coupled via clutch 101 to output drive shaft 41 of engine 7. First pulley 102 mechanically engages drive belt 104 to transfer torque to second pulley 105, both of which have a common axis of rotation parallel to the axis of rotation of the output drive shaft 41 of the engine 7. In the present embodiment, second pulley 105 is larger than first pulley 102. This serves to lessen an undesirably high amount of torque being applied to drive wheel 11 which may cause the user to lose control of the bicycle, especially in the initial acceleration phase. However, it can be appreciated that in situations where higher levels of torque are desired, a size ratio closer to 1:1 for first pulley 102 and second pulley 105 can be employed. The pulley ratio also may be used to regulate the maximum speed of the trailer of the trailer.

In the present embodiment, the second pulley 105 is mechanically connected to a drive axle 107 which, in turn, is mechanically fixed to a first externally-toothed sprocket 106. Thus, the second pulley 105 is capable of driving the first sprocket 106. The first sprocket 106 is further connected by way of a drive chain 108 to a second externally-toothed sprocket 109, which is mechanically coupled to drive wheel 11. The drive axle 107, first sprocket 106 and second sprocket 109 all have a common axis of rotation parallel to the axis of rotation of pulleys 102, 105 and engine output drive shaft 41. The second sprocket 109 incorporates a ratcheted bearing for purposes of permitting freewheeling of the drive wheel 11 when no power is being applied to the drive wheel 11.

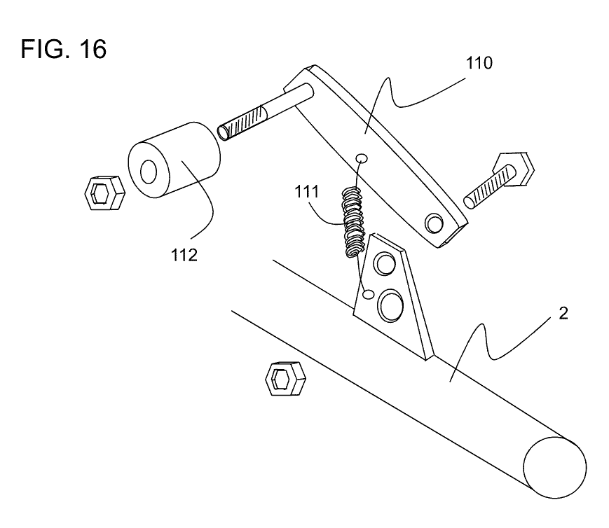

A belt tensioner 103 may be employed to facilitate the operation of the first and second pulleys 102, 105. The tensioner 103, as seen in FIG. 16, assists in maintaining a relatively constant tension on the drive belt 104 especially when fluctuations occur in the engine output to the front pulley 105 that could result in belt slippage or stretch due to factors such as acceleration or deceleration of the front pulley 105. The tensioner 103 includes a rotatable lever arm 110 pivotably affixed at one end to the frame 2 and a roller bearing 112 affixed at the opposing free end for contacting and tensioning the drive belt 104 at a point between the first and second pulleys 102, 105. A tensioning spring 111 extends between the frame 2 and the lever arm 110 to provide a spring bias to the tensioner 103 against the drive belt 104.

In addition to the above, there should also be provided a way to lock the cart. A means should be provided on one or both of the trailer's arms near the bicycles hub so that the cart may be locked to the bicycle. In one embodiment provides for a small plate with a hole in it is fixed to the front fork so that a cable or chain may be fastened to it. Another embodiment includes providing a hole in both the tongue and the clamping plate to allow a padlock to secure the bicycle and cart together. In a further embodiment, and in particular to accommodate locking of the tow bar 39, a fixed ring attached to the tow bar 39 near the bicycle seat could be used to lock the trailer to the bicycle frame or any other object to help prevent theft.

Furthermore, an electric start or alternatively, an extension of the pull-start may be provided so that the cart could be started without having to dismount the bicycle. This embodiment would include a cable or rope and guides and would use a clip and barrel or other means of a detachable connection located near the cart's point of attachment so that the cart could still be easily removed from the bicycle.

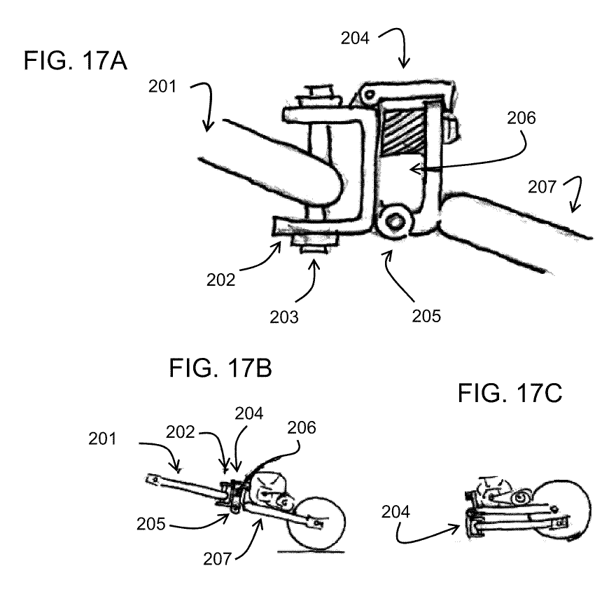

In another embodiment, shown in FIGS. 17A-17C, the rear fork hitch has a means to fold the front fork underneath the trailer for carrying or storage. The front and rear forks 201 and 207 of a trailer are allowed to pivot about the vertical plane by way of a hinge 205. A U-joint 202 and an axle and bearing assembly 203 allow the front fork 201 to easily fold. A latch 204 keeps the two forks from folding while in operation yet some rotational motion may be desirable for suspension. This drawing shows a rubber dampener 206 however a spring or dampening piston would work as well.

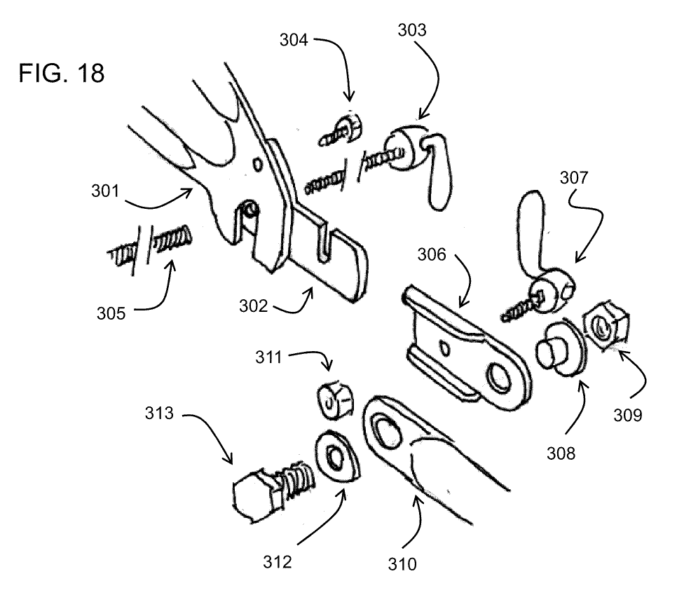

In yet another embodiment, a quick release mounting system may be employed as shown in FIG. 18. A mounting plate 302 is semi-permanently fastened to the bicycle by way of the normal bicycle hub fastening system. A hole or slot may be included in the plate that utilizes the hole or holes commonly provided on bicycle dropouts to fasten a rack in order to provide extra fastening strength to the mounting plate as considerable forces may be applied to it during operation. This provides a secure tongue with a slot (drop in) at each bicycle hub dropouts. A clamp 306 may then be easily fastened to the tongue 302 and secured by fasteners 307 and 311. Ridges may be supplied to help hold the clamp 306 and the mounting plate 302 in alignment. The arm of a trailer front fork 310 may then be semi-permanently fixed to the clamp 306 by way of a bushing 308 and fasteners 309 and 313. This system allows for rotational motion about the bearing 308 while providing a very secure means of attachment that is easily removed from the bicycle.

The quick release mounting system in FIG. 18 includes the following components:

301 Bicycle Dropout

302 Mounting Plate

303 Bicycle Hub Quick Connect Skewer

304 Locking Screw

305 Bicycle Axle

306 Clamp

307 Cammed Tensioner

308 Bushing or Bearing

309 Fastener

310 One Arm of Trailer Front Fork

311 Nut

312 Bearing

313 Bolt

Since certain changes may be made in the above-described invention, without departing from the spirit and scope of the invention herein involved, it is intended that all of the subject matter of the above description or shown in the accompanying drawings shall be interpreted merely as examples illustrating the inventive concept herein and shall not be construed as limiting the invention.

I/we claim:

1. A powered bicycle trailer for propelling a bicycle and a human rider, comprising:
a trailer frame;
an adapter for connecting to a bicycle;
a connecting arm for rotatably connecting the trailer frame to the adapter such that the frame is rotatable about at least one of a horizontal axis and a vertical axis relative to the bicycle;
a power generation system that attaches to the trailer frame;
a first control assembly that attaches to the bicycle, facilitating rider control of the power generation system and a second control assembly that attaches to the power generation system;
a ground engaging member;
a power transmission system mechanically coupled to an output drive of the power generation system and capable of driving the ground engaging member; and
wherein the trailer frame and control assembly is rapidly mountable and dismountable from the bicycle by a quick release coupling between the first and second control assemblies.

2. The bicycle trailer as recited in claim 1 wherein the vehicle-mounted adapter attaches adjacent to a hub of a rear wheel of a bicycle.

3. The bicycle trailer as recited in claim 1 wherein the vehicle-mounted adapter attaches adjacent a seat post of a bicycle.

4. The bicycle trailer as recited in claim 1 wherein the power generation system is an electric motor.

5. The bicycle trailer as recited in claim 1 further comprising a fuel tank and a means for delivering fuel from the fuel tank to the power means, where the power means is a combustion motor capable of running on gasoline or diesel fuel.

6. The bicycle trailer as recited in claim 5 wherein the power means further comprises a hybrid power system incorporating an electric motor.

7. The bicycle trailer as recited in claim 1 further comprising an external cowling adapted to fit over the power system and power transmission system and provide access thereto.

8. The bicycle trailer as recited in claim 1 wherein the ground engaging member comprises a wheel assembly mounted on the frame and having a tire constructed of rubber or other elastomer and an axle.

9. The bicycle trailer as recited in claim 1 wherein the power generation system further comprises an output drive shaft, and:
a first pulley mounted to the output drive shaft of the power means;
at least a second pulley fixed to a drive axle;
one of a belt or chain for transferring output power between the first pulley and second pulley; and
wherein the drive axle and second pulley have a common axis of rotation parallel to the axis of rotation of the output drive shaft of the power generation system.

10. The bicycle trailer as recited in claim 1 wherein the quick release coupling between the first control assembly and second control assembly are attached by means of the attracting forces of dissimilar pole magnets.

11. The bicycle trailer as recited in claim 1 wherein the first coupling mechanism of the connecting arm incorporates a forked end and the vehicle-mounted adapter incorporates protruding pins extending outwardly therefrom, the forked end configured to dismountably interface with the pins.

12. The bicycle trailer as recited in claim 11, wherein the first coupling mechanism of the connecting arm further comprises a tension spring-biased engageable latch for retaining the pin within the forked end.

13. The bicycle trailer as recited in claim 1, wherein the second coupling mechanism of the connecting arm is configured with pin openings to receive and retain a vertical hitch pin; and
the frame further comprises a vertical hitch pin, an upper hitch tongue and a lower hitch tongue, the upper hitch tongue and lower hitch tongue each configured with vertically-oriented pin openings capable of interfacing with the pin openings in the connecting arm and receiving a vertical hitch pin for rotatably securing the connecting arm to the frame such that the frame is permitted to rotate around a vertical axis in relation to the connecting arm.

14. The trailer of claim 1, wherein the frame further comprises an extensible and retractable front portion wherein the length of the frame can be made longer to allow stowage of cargo.

15. A powered bicycle trailer for propelling a bicycle, a human rider, and cargo, comprising:
a frame for attachment to a bicycle;
a vertical and horizontally aligned axis of rotation positioned between the frame and the bicycle permitting relative rotation of the frame relative to the bicycle;
a power means supported on the frame having a first throttle cable and capable of generating an output drive;
a power means control system for mounting on the bicycle comprising a throttle control attached to a second throttle cable and a quick connect and disconnect device for connecting the second throttle cable to the first throttle cable;
a power transmission system mechanically coupled to an output drive of the power means for driving a ground engaging member; and
wherein the trailer is rapidly mountable and dismountable via the quick connect and disconnect device between the first and second throttle cables.

16. The bicycle trailer as recited in claim 15 wherein the quick connect and disconnect device between the first throttle cable and second throttle cable are attached by means of the attracting forces of dissimilar pole magnets.

17. A method of propelling a bicycle, a human rider, and cargo, comprising the steps of:
attaching a trailer having a frame to a bicycle;
positioning a vertical and horizontally aligned axis of rotation between the frame and the bicycle permitting relative rotation of the frame relative to the bicycle;
supporting a power means on the frame having a first throttle cable and capable of generating an output drive;
mounting a power means control system on the bicycle comprising a throttle control attached to a second throttle cable and a quick connect and disconnect device for connecting the second throttle cable to the first throttle cable;
coupling a power transmission system mechanically between an output drive of the power means and a ground engaging member; and
one of rapidly mounting and dismounting the trailer from the bicycle via the quick connect and disconnect device between the first and second throttle cables.

18. The method as set forth in claim 17 further comprising the steps of attaching the quick connect and disconnect device between the first throttle cable and second throttle cable by means of the attracting forces of dissimilar pole magnets.
